(19) United States
(12) Patent Application Publication
(10) Pub. No.: US 2005/0273309 A1
(43) Pub. Date: Dec. 8, 2005

(54) Circuit simulation method, device model, and simulation circuit

(75) Inventors: Shinichiro Yoneyama, Akashi-shi (JP); Hideki Mishima, Takatsuki-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/143,599

(22) Filed: Jun. 3, 2005

(30) Foreign Application Priority Data
Jun. 4, 2004 (JP) 2004-166736

(51) Int. Cl. G06F 17/50

(52) U.S. Cl. 703/14

(57) ABSTRACT

A plurality of elements constituting a semiconductor integrated circuit to be designed are each converted to a device model which merges an electric model exhibiting electric characteristics of the element and a thermal model exhibiting thermal characteristics of the element, and a thermal resistor is inserted between the elements where heat exchange occurs, thereby electric and thermal circuits are formed. Then circuit and heat equations are formulated with respect to the electric and thermal circuits, and then the equations are solved together to acquire electric and thermal characteristics of each element in the circuit. As a result, it becomes possible to achieve high-precision device characteristics which precisely reflect the temperature variation of each element in the circuit during simulation.

### BACKGROUND OF THE INVENTION

1. Field of the Invention

The present invention relates to a circuit simulation method through which circuit properties are evaluated using a circuit simulator in the design of semiconductor integrated circuits, in particular, in a step of designing the semiconductor integrated circuits. Also, the invention relates to a device model and a simulation circuit to be used in this method.

2. Background Art

In semiconductor integrated circuits (ICs) which control apparatus requiring large currents for driving, such as motors and plasma displays, temperatures of elements constituting the ICs or of the entire ICs dynamically varies during their simulation due to self-heating and so on, so that the characteristics of the ICs used for the apparatus requiring large currents are more likely to decline than ICs used for apparatus requiring no large current. Because of this, it is essential to understand temperature regions which the ICs or the elements are likely to reach and to take sufficient measures against the possibility at the time of the circuit design.

For the evaluation of the circuit characteristics of the ICs, circuit simulators are used often. As a typical circuit simulator, there is a circuit simulator based on an algorithm adopted in SPICE (Simulation Program with Integrated Circuit Emphasis) developed at UCB (University of California, Berkeley Campus, USA). In this circuit simulator, the dynamic variation of the electric characteristics of elements in a circuit is simulated. Here the temperature of the elements is assumed to be constant during the simulation.

Also, in some active devices such as VBIC95 (Vertical Bipolar Inter-Company model 1995) developed through the Bipolar/BiCMOS Circuits and Technology Meeting of the IEEE, simulation models, in which the temperature variation of elements caused by self-heating during the simulation is also taken into account, have been made available in recent years. However, in most devices such as passive devices, only dynamic variation in electric characteristics is still simulated. Because of this, dynamic variation in temperature across entire ICs has not been able to be simulated precisely.

Furthermore, as a simulation method in which the self-heating is taken into account, a technique of taking account of temperature, that is, the temperature variation of individual elements in a circuit during simulation has been proposed in Patent Reference 1 below. This technique will be described with reference to FIGS. 12 and 13.

To begin with, a device model to be used in the circuit is prepared on the assumption that the temperature of each element does not vary. As the configuration of the model, an electric model 81 provided with terminals P1 to Pn whose number corresponds to the device and a parameter 82 indicating the temperature of the element are main components as shown in FIG. 12. Symbol Z denotes electrical impedance of the element, and Symbol temp denotes a variable indicating the temperature of the element. The term element refers to components themselves arranged in the integrated circuit, such as resistors and MOS transistors. Also, the term device is used to mean structures to which the elements, such as the resistors and the MOS transistors, belong.

As shown in FIG. 13, through the use of this model, a circuit equation is formulated provided that the temperature of the elements is constant (which corresponds to Step 91).

Next, electric characteristics, such as voltages at the circuit and currents of the circuit, are calculated based on the circuit equation, the input condition of the circuit, and the temperature of each element, and then the currents flowing through each element are calculated (which corresponds to Step 92).

Then the quantity of the self-heating and temperature variation of each element are calculated (which corresponds to Step 93).

Here the quantity of the temperature variation of each elements are examined, and the determination whether the total quantity of the temperature variations falls within a specified value is made (which corresponds to Step 94).

When the total quantity of the temperature variations exceeds the specified value, the temperature of each element is reset in a state modified by the calculated quantity of the temperature variation (which corresponds to Step 95), and then a return to the step of solving a circuit equation is made. When the determination that the total quantity of the temperature variations falls within the specified value is made, the values of the electric characteristics and the temperature of each element acquired are considered to be the state of the circuit at this time.

In the following, Patent Reference 1 and another reference will be provided.

Patent Reference 1: JP-A No. 8-327698 (see FIG. 1)

Non-Patent Reference 1: “VBIC 95, The Vertical Bipolar Inter-Company Model” by IEEE, Journal of Solid-State Circuits, October 1996, Vol. 31, No. 10.

According to the conventional art techniques, however, in the simulation of, for instance, transient response of the circuits, only the self-heating is taken into account as the factor of the temperature variation, while the exchange of heat quantities between the elements in the circuits is not taken into account as the factor. Because of this, the accuracy of a circuit simulation conducted for acquiring the characteristics of a temperature-dependent device deteriorates.

In addition, as for the technique described in Patent Reference 1, it is necessary to repeatedly calculate the temperature for the purpose of determining the state of the circuit at checking times, so that this technique brings about a significant increase in process time when compared with conventional circuit simulations in which the temperature variation of elements is not taken into account.

### SUMMARY OF THE INVENTION

An object of the present invention is to provide a circuit simulation method by which a high-precision circuit simulation taking account of exchanges of heat quantities between elements in the circuit is implemented, and a device model and a simulation circuit used in the method.

Another object of the invention is to provide a circuit simulation method, through which an efficient circuit simulation is implemented through the reduction of repetitive steps during the simulation, and a device model and a simulation circuit used in the method.

The circuit simulation method according to the invention includes a step of forming a simulation circuit in which not only individual elements in the circuit to be simulated are represented as a device model which has an electric model exhibiting electric characteristics of the element, in which the temperature variation of the element is taken into account, and which has a thermal model exhibiting thermal characteristics of the element, but also a thermal resistance between the two elements where the heat exchange occurs is determined to be inserted between the thermal models of the device models corresponding to the two elements. The circuit simulation method also includes a step of determining dynamic variations in the electric and thermal characteristics of each element in the circuit to be simulated through the analysis of the simulation circuit.

To determine the thermal resistance value between the elements where the heat exchange occurs, it is preferable that the step of forming the simulation circuit included in the circuit simulation method includes a step of choosing any two of the elements placed so as to be adjacent to each other from a mask layout as the two elements where the heat exchange occurs and a step of determining the thermal resistance value between the two elements based on a distance between the two elements placed so as to be adjacent to each other and on a thermal conductivity between the two elements.

To represent the function of the individual elements in the circuit to be simulated, the device model according to the invention has the electric model exhibiting the electric characteristics, in which the temperature variations of the elements are taken into account, and the thermal model exhibiting the thermal characteristics of the elements, so that the device model is applicable to the circuit simulation method.

In the simulation circuit according to the invention, each element in the circuit to be simulated is represented in the form of the device model which has the electric model exhibiting the electric characteristics, in which the temperature variation of the element is taken into account, and which has the thermal model exhibiting the thermal characteristics of the element. Also, in the simulation circuit, the thermal resistances between the elements where the heat exchange occurs are inserted between the thermal models of the device models corresponding to the elements. From these advantages, the simulation circuit is applicable to the circuit simulation method of the invention.

According to the circuit simulation method of the invention, it is possible to obtain the electric and thermal characteristics of each element in the circuit through the consideration of the heat exchange between the elements and through the elimination of the repetitive calculation of the temperatures during the simulation, thereby a high-precision and efficient circuit simulation can be implemented.

### BRIEF DESCRIPTION OF THE DRAWINGS

FIG. 1 is a configurational diagram of a simulation model of an element according to the present invention;

FIG. 2 is a flowchart of a circuit simulation method according to the invention;

FIGS. 3A and 3B are configurational diagrams of a simulation model of a resistive element according to an embodiment of the invention;

FIGS. 4A to 4C are a circuit diagram of a circuit to be simulated according to the embodiment of the invention and are layout drawings of the circuit;

FIG. 5 is a circuit diagram of a simulation circuit configured in the embodiment according to the invention;

FIGS. 6A and 6B are graphs for showing transient responses of the temperature of elements during power-on of resistive elements according to the embodiment of the invention;

FIGS. 7A and 7B are graphs for showing correlation of the temperature and the resistance value of the elements with power supply voltage at the resistive elements according to the embodiment of the invention;

FIG. 8 is a flowchart of a method for determining thermal resistances between adjacent elements according to the embodiment of the invention;

FIG. 9 is a detailed flowchart of Step S12 shown in FIG. 8;

FIG. 10 is a detailed flowchart of Step S22 shown in FIG. 9;

FIGS. 11A to 11D are diagrams for explaining a method for determining element adjacency relationships according to the embodiment of the invention;

FIG. 12 is a configurational diagram of a model of an element used for a conventional art circuit simulator;

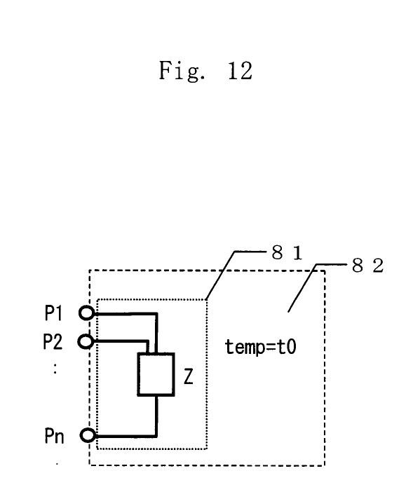

FIG. 13 is a flowchart for explaining a method for calculating an analytic point on a conventional art circuit simulator which takes account of self-heating; and

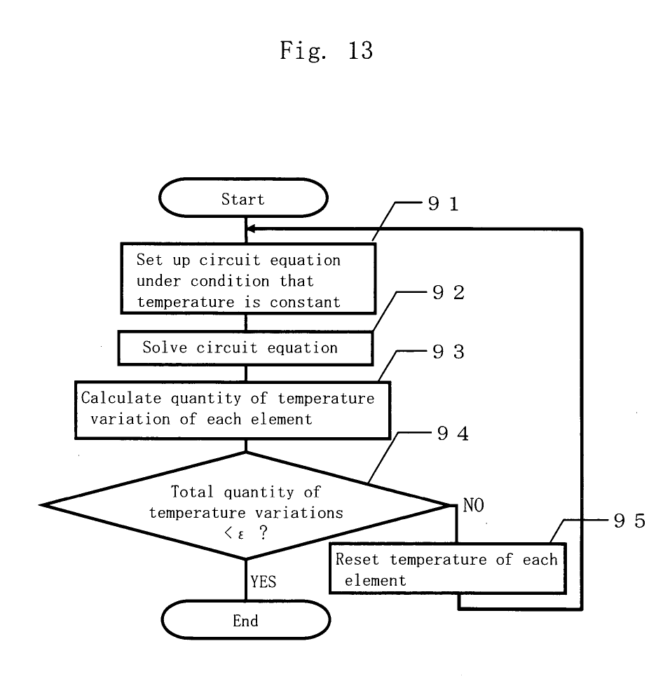

FIGS. 14A to 14C are diagrammatic illustrations of a procedure shown in the flowchart of FIG. 9.

### DESCRIPTION OF THE PREFERRED EMBODIMENT

In the following, an embodiment according to the present invention will be explained with reference to the drawings.

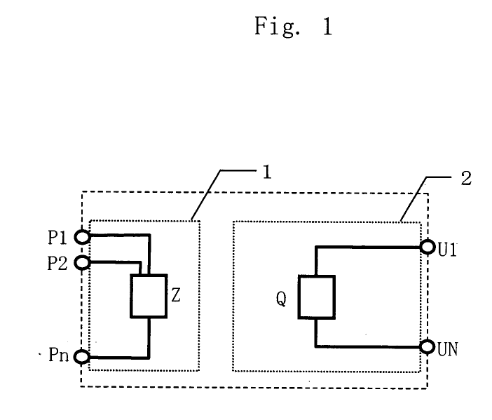

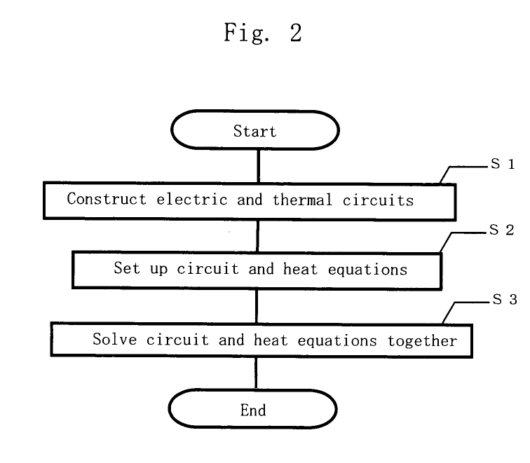

FIG. 1 is a schematic diagram of a device model used for a circuit simulation according to the invention, and FIG. 2 is a flowchart of a circuit simulation method according to the embodiment.

Roughly explaining, the device model used for the circuit simulation according to the invention is a model which merges an electric model 1 exhibiting the electric characteristics of an element and a thermal model 2 exhibiting the thermal characteristics of the element (hereinafter referred to as “electro-thermal merge model”) as shown in FIG. 1.

The electric model 1 is provided with terminals P1 to Pn whose number varies according to the type of the device, and the thermal model 2 is provided with terminals U1 and UN capable of exchanging heat quantities between the elements (hereinafter referred to as “thermal terminal”). The electric model 1 varies its electric properties (for instance, the resistance of the element) in response to the dynamic variation in the thermal characteristics of the thermal model 2 (the temperature variation of the element).

In FIG. 1, symbol Z denotes the electrical impedance of the element, and Symbol Q denotes the thermal impedance of the element. The thermal terminal U1 is the terminal of the thermal model which indicates the temperature of the terminal, and the thermal terminal UN is the terminal of the thermal model connected to the terminal for a reference temperature.

A circuit simulator uses such an electro-thermal merge model. The circuit simulator converts all of the plurality of elements, which constitutes a semiconductor integrated circuit to be designed, to the electro-thermal merge model as shown in FIG. 2, and provides with a thermal resistor inserted between the elements where the heat exchange occurs (for instance, between the adjacent elements). As a result, electric and thermal circuits using the electro-thermal merge model are formed (which corresponds to Step S1).

Next, a circuit equation and a heat equation are set up in regard to the constructed electric and thermal circuits (which corresponds to Step S2) and then solved together (which corresponds to Step 3), thereby the electric and thermal characteristics of each element in the circuit can be obtained.

The circuit simulator using the electro-thermal merge model according to the embodiment has the function of determining the temperatures of the elements, which dynamically vary through self-heating during the simulation and the exchanges of heat quantities between the elements in the circuit, and the electrical quantities of the circuit together. Therefore, when a point during the simulation is analyzed, it is possible to obtain the electric and thermal characteristics of each element in the circuit without repeatedly calculating the temperatures as shown in FIG. 2.

In the following, the embodiment will be explained in detail by taking a resistive element as an example of the elements.

To begin with, the simulation model (electro-thermal merge model) of the resistive element is constructed.

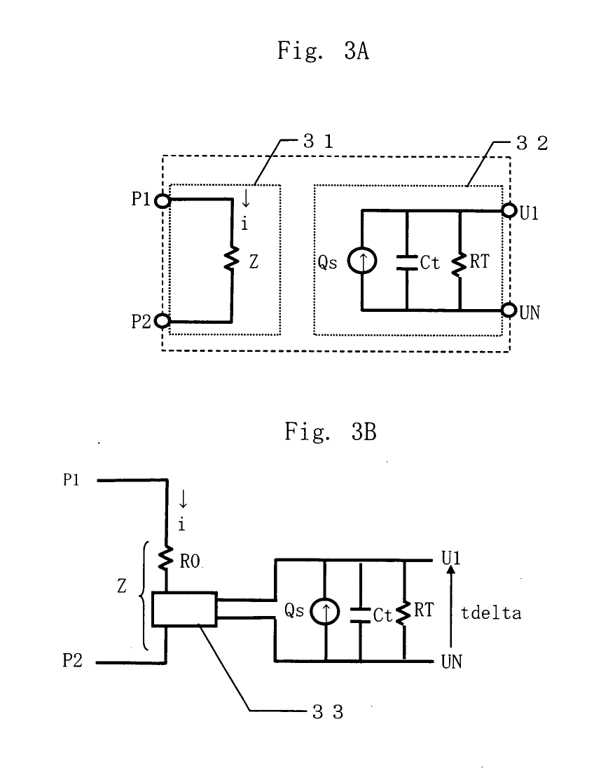

As the model of the resistive element, an electro-thermal merge model shown in FIG. 3A is provided. In this model, a heat source Qs produced by self-heating, a thermal capacitor Ct accumulating the heat quantity, and a thermal resistor RT radiating the heat to a substrate are connected in parallel to one another. Furthermore, thermal terminals U1 and UN are introduced to the nodes of the thermal circuit. The thermal terminal U1 indicates the temperature of the resistive element. To the thermal terminal UN, a heat source used for setting the element at a reference temperature (for instance, room temperature) is connected when the element has no self-heating and heat exchange with other elements. Symbol i denotes current flowing into a resistor having electrical impedance Z.

In FIG. 3A, an electric model 31 is indicated as in the case of the model of a resistor adopted in the conventional circuit simulators, and a thermal model 32 is indicated as in the case of the thermal model adopted in the VBIC95. However, as shown in FIG. 3B, the electrical impedance Z is actually composed of a reference resistance R0 indicating a resistance at the reference temperature of the resistive element and a correction resistance RC of a correcting circuit 33. When the temperature of the resistive element exceeds the reference temperature by tdelta, the correction resistance RC of the correcting circuit 33 can be set in such a way that Qs=iZ². Here the meaning of “tdelta” is as follows:

tdelta=temperature of thermal terminal U1-temperature of thermal terminal UN.

When the temperature of the element exceeds the reference temperature by tdelta, the electrical impedance Z is as follows:
Z=R0 (1+tc1*tdelta+tc2*tdelta²)
where Symbols tc1 and tc2 denote temperature coefficients. Because of this, the correction resistance RC of the correcting circuit 33 is set as follows:
RC=R0 (tc1*tdelta+tc2*tdelta²).

Furthermore, the heat quantity Q1 radiated from the element to the substrate by the thermal resistor RT is indicated as follows:
Q1=tdelta/RT.
In a state of equilibrium, the following equality is set up:
Qs=Q1.

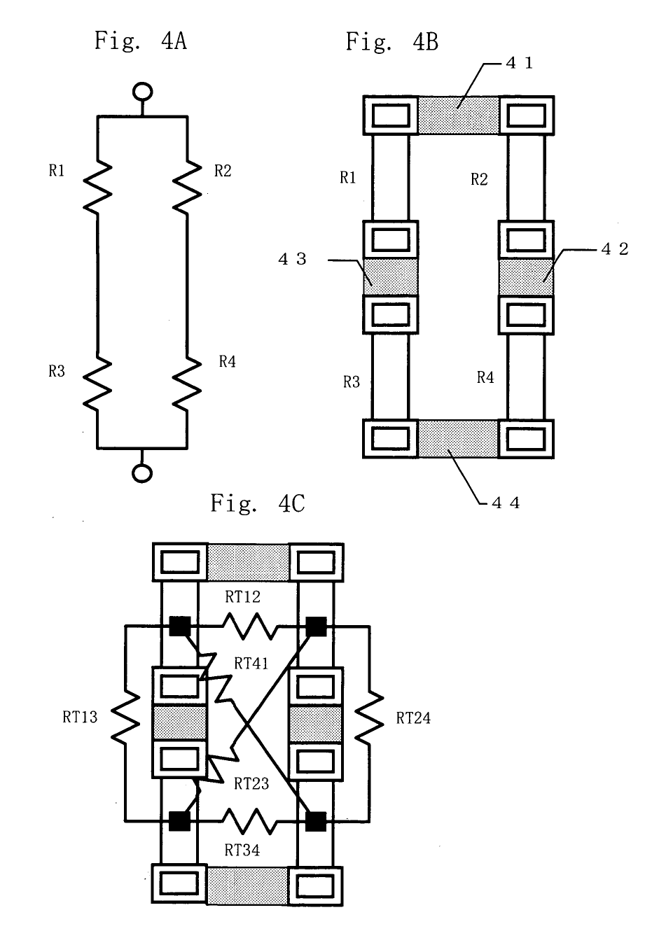

In FIGS. 4A to 4C, an example is illustrated as a circuit to be simulated. FIG. 4A is a circuit diagram of the circuit to be simulated, and FIG. 4B is a layout drawing thereof. The circuit to be simulated includes four resistive elements R1 to R4 as shown in FIG. 4A and configured as shown in FIG. 4B. In FIG. 4B, reference numerals 41 to 44 denote wirings made of aluminum or the like, and the individual resistive elements R1 to R4 are connected one after another via one of the wirings 41 to 44.

In the layout pattern shown in FIG. 4B, there are six sets with respect to the combination of the two resistive elements having the possibility of producing the heat exchange between the four resistive elements R1 to R4. The heat exchange between the two resistive elements is indicated in the form of a thermal resistor. In FIG. 4C, the six thermal resistors are shown schematically based on the layout pattern shown in FIG. 4B. Symbol RT12 denotes the thermal resistor between the resistive elements R1 and R2, Symbol RT23 denotes the thermal resistor between the resistive elements R2 and R3, Symbol RT34 denotes the thermal resistor between the resistive elements R3 and R4, Symbol RT41 denotes the thermal resistor between the resistive elements R4 and R1, Symbol RT13 denotes the thermal resistor between the resistive elements R1 and R3, and Symbol RT24 denotes the thermal resistor between the resistive elements R2 and R4.

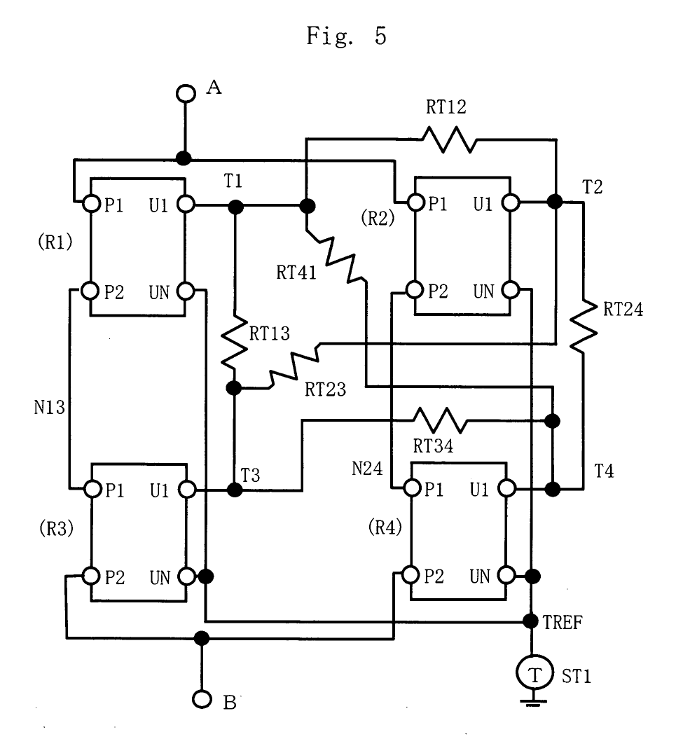

FIG. 5 is a circuit diagram of a simulation circuit (electric and thermal circuits) prepared using the resistance model shown in FIGS. 3A and 3B based on the circuit to be simulated shown in FIGS. 4A to 4C. In FIG. 5, Symbol ST1 denotes a constant temperature source, Symbols (R1) to (R4) denote the models of the resistive elements R1 to R4, Symbols T1 to T4 denote thermal nodes, and Symbol TREF denotes the reference temperature node of the resistive elements R1 to R4.

In this simulation circuit, the thermal resistors RT12, RT23, RT34, RT41, RT13, and RT24 are each connected to the thermal terminal U1 of the corresponding elements (R1) to (R4) The thermal resistance values of these thermal resistors RT12, RT23, RT34, RT41, RT13, and RT24 are determined by factors affecting heat conduction between the resistive elements R1 to R4 such as material and distances between the resistive elements R1 to R4.

Here circuit and heat equations of the configuration shown in FIG. 5 will be described. With this simulation circuit, a net connecting the terminal P2 of the element (R1) and the terminal P1 of the element (R3) and a net connecting the terminal P2 of the element (R2) and the terminal P1 of the element (R4) are denoted as N13 and N24 respectively. Voltages at terminals A and B and at the nets N13 and N24 are denoted as V(A), V(B), V(N13), and V(N24) respectively. Furthermore, when current flowing in to the terminal A and current flowing out of the terminal B are denoted as I(A) and -I(B) respectively, the circuit equation is expressed as follows:

$$I ( A ) = \frac{V ( A ) - V ( N13 )}{{Z}_{R1} ( T1 , TREF )} + \frac{V ( A ) - V ( N24 )}{{Z}_{R2} ( T2 , TREF )} \\ - I ( B ) = \frac{V ( N13 ) - V ( B )}{{Z}_{R3} ( T3 , TREF )} + \frac{V ( N24 ) - V ( B )}{{Z}_{R4} ( T3 , TREF )} \\ 0 = \frac{V ( A ) - V ( N13 )}{{Z}_{R1} ( T1 , TREF )} - \frac{V ( N13 ) - V ( B )}{{Z}_{R3} ( T3 , TREF )} \\ 0 = \frac{V ( A ) - V ( N24 )}{{Z}_{R2} ( T2 , TREF )} - \frac{V ( N24 ) - V ( B )}{{Z}_{R4} ( T4 , TREF )} \qquad ( expression 1 )$$

where Symbols Z_{R1}(T1, TREF), Z_{R2}(T2, TREF), Z_{R3}(T3, TREF), and Z_{R4}(T4, TREF) denote the impedances of the elements (R1) to (R4). Furthermore, the heat equation is expressed as follows:

$$Q ( R1 ) = \frac{T1 - T2}{RT12} + \frac{T1 - T3}{RT13} + \frac{T1 - T4}{RT41} \\ Q ( R2 ) = \frac{T2 - T1}{RT12} + \frac{T2 - T3}{RT23} + \frac{T2 - T4}{RT24} \\ Q ( R3 ) = \frac{T3 - T1}{RT13} + \frac{T3 - T2}{RT23} + \frac{T3 - T4}{RT34} \\ Q ( R4 ) = \frac{T4 - T1}{RT41} + \frac{T4 - T2}{RT24} + \frac{T4 - T3}{RT34} \qquad ( expression 2 )$$

where Q(Rx) is a heat quantity radiated from the terminal T1 of the resistance Rx.

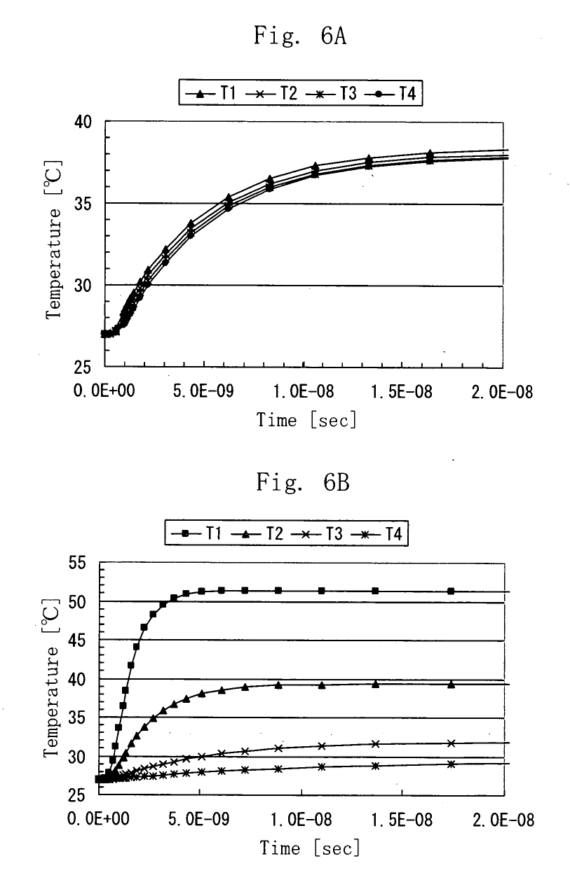

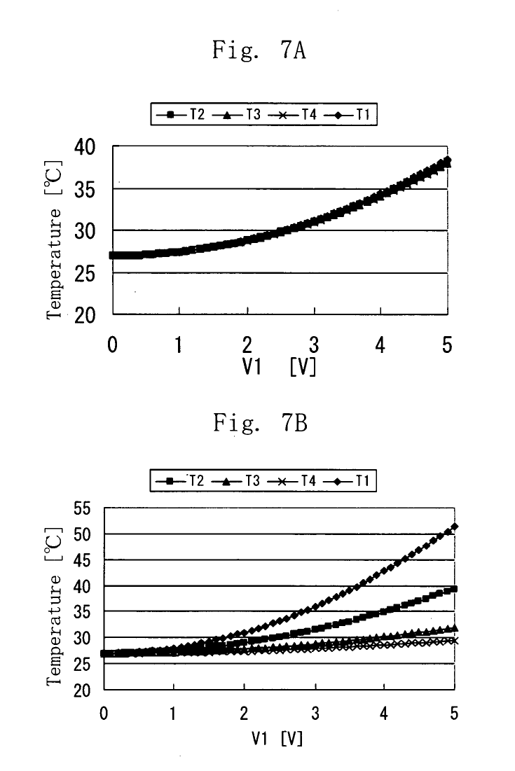

By way of example, results of the circuit simulation conducted by using the circuit shown in FIG. 5 whose voltage source SV1 is connected between the terminals A and B is indicated in FIGS. 6A, 6B, 7A, and 7B. Here all the thermal resistances between the elements take on the same value for simplicity.

In FIGS. 6A and 6B, the examples of the circuit simulation results obtained by transiently varying voltage V1 applied to the circuit by the voltage source SV1 (at power-on), that is, the examples of transient analysis are indicated. In FIG. 6A, the example of the circuit simulation results of this embodiment taking account of the heat exchanges between the elements through the use of the six thermal resistors RT12, RT23, RT34, RT41, RT13, and RT24 is indicated. Furthermore, when the six thermal resistors are removed, a simulation result brought about at the time when the temperature of each element varies due to only the self-heating thereof can be obtained. The simulation result brought about by only the self-heating is shown in FIG. 6B.

In FIGS. 7A and 7B, a correlation between the voltage V1 at the voltage source SV1 and the temperatures of the resistive elements found by DC analysis is exemplified. The analytical results according to the embodiment in which there are the heat exchanges between the elements due to the thermal resistors is exemplified in FIG. 7A, and the analytical results brought about only by the self-heating is exemplified in FIG. 7B.

In this embodiment, it is found from FIGS. 6A, 6B, 7A, and 7B that since the heat exchanges between the elements are taken into account, the simulation results can be obtained with a high degree of precision.

Next, a method for determining the thermal resistances between the elements will be described in detail.

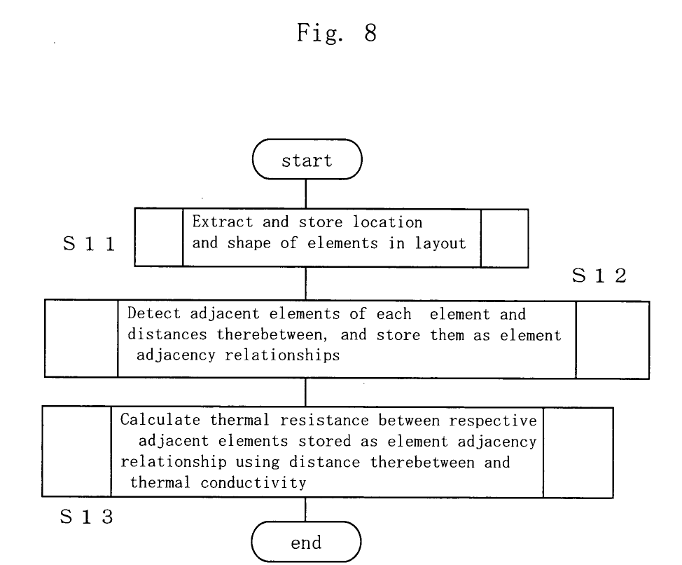

As shown in FIG. 8, the location and shape of the elements are initially extracted from the layout of a semiconductor integrated circuit to be simulated and stored (which corresponds to Step S11).

Then, elements adjacent to the individual elements stored in Step 11 are detected, and the element adjacency relationship thereof is stored (which corresponds to Step S12). Information on the element adjacency relationship includes pieces of information on the adjacent elements determined (for example, the element names) and on distances between the elements.

Further, the thermal resistance values between the adjacent elements based on the stored individual adjacency relationship are determined. The thermal resistance values are calculated from the distances between the adjacent elements and the thermal conductivity of the material therebetween (Si, SiGe, etc.) (which corresponds to Step S13).

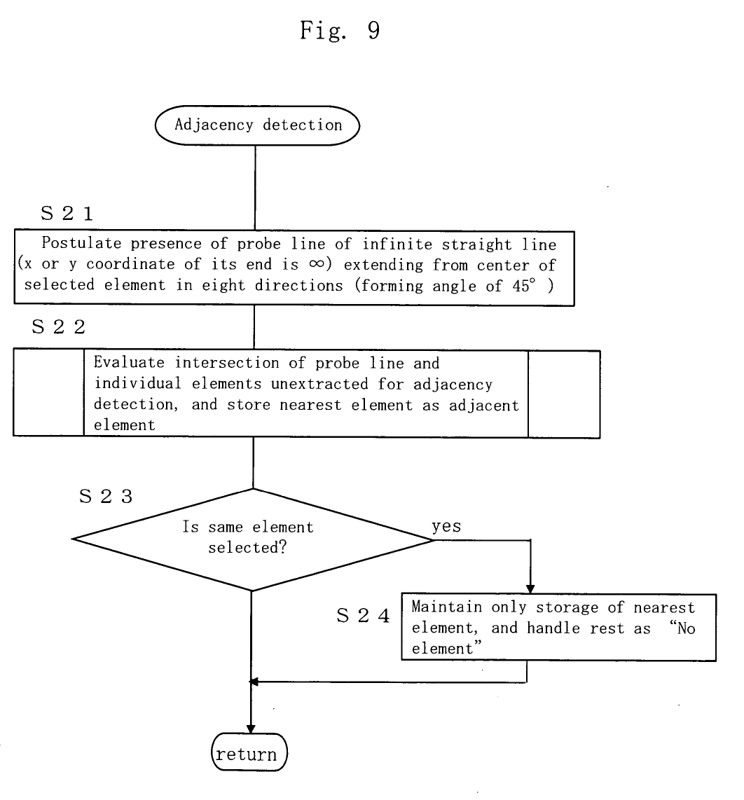

FIG. 9 is a flowchart of a detailed procedure included in Step S12 shown in FIG. 8. To begin with, a straight line (probe line) extending from the center of any element selected in eight directions is postulated (which corresponds to Step S21). Then, the intersections of the individual elements and the probe line are evaluated, the element which is nearest to the selected element is determined as an adjacent element, and the adjacency relationship of the two adjacent elements (including a distance therebetween) is stored (which corresponds to Step S22). The determination whether the same element is chosen is made (which corresponds to Step S23). When the same element is chosen, only the storage of the shortest distance is maintained, and the rest is handled as “no element” (which corresponds to Step S24).

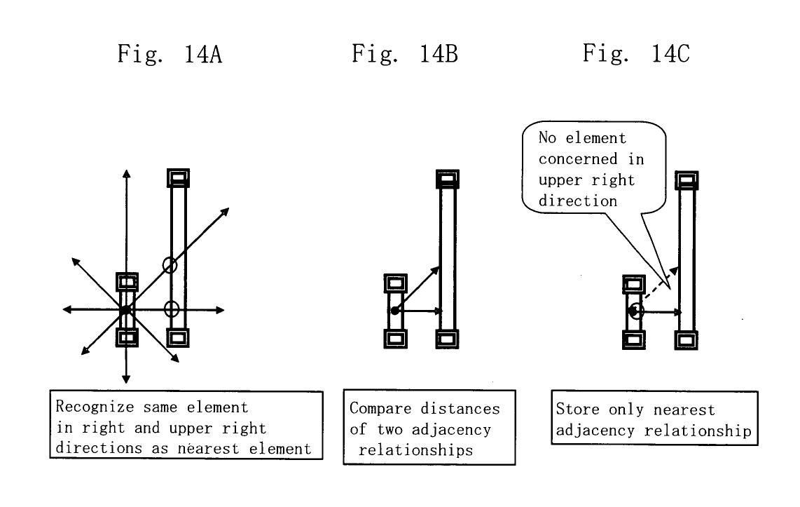

In FIGS. 14A to 14C, the procedure shown in the flowchart of FIG. 9 is indicated concretely. For instance, when an adjacent element is long, the adjacent element is recognized as the nearest element based on the right and upper right directions as shown in FIG. 14A. Next, as shown in FIG. 14B, distances of the two adjacency relationships are compared, and then, as shown in FIG. 14C, only the nearest adjacency relationship is stored.

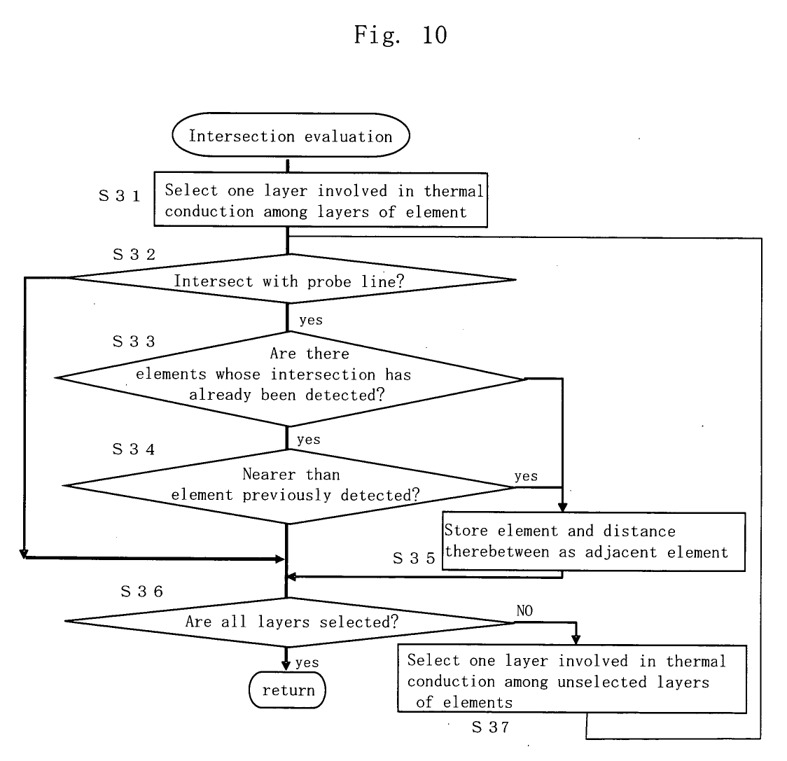

The detail of Step S22 shown in FIG. 9 is indicated in FIG. 10. As shown at Steps S31 to S37 in FIG. 10, among the layers of the element, one layer involved in the heat conductivity is selected (which corresponds to Step S31), and the intersection of the element of the selected layer and the probe line is checked (which corresponds to Step S32). When the element of the selected layer intersects with the probe line, provided that there is an element having intersection already detected (which corresponds to Step S33), and the element of the selected layer is nearer than the element whose intersection has been already detected (which corresponds to Step S34), the selected element is stored as an adjacent element in conjunction with a distance therebetween (which corresponds to Step S35). When there is no element having intersection already detected, the selected element is stored as an adjacent element in conjunction with a distance therebetween (which corresponds to Step S35). The layers of all the elements involved in the heat conduction are subjected to these steps (which corresponds to Steps S36 and S37). That is, the steps are performed on all the layers involved in the heat conduction of the plurality of layers which make up the element.

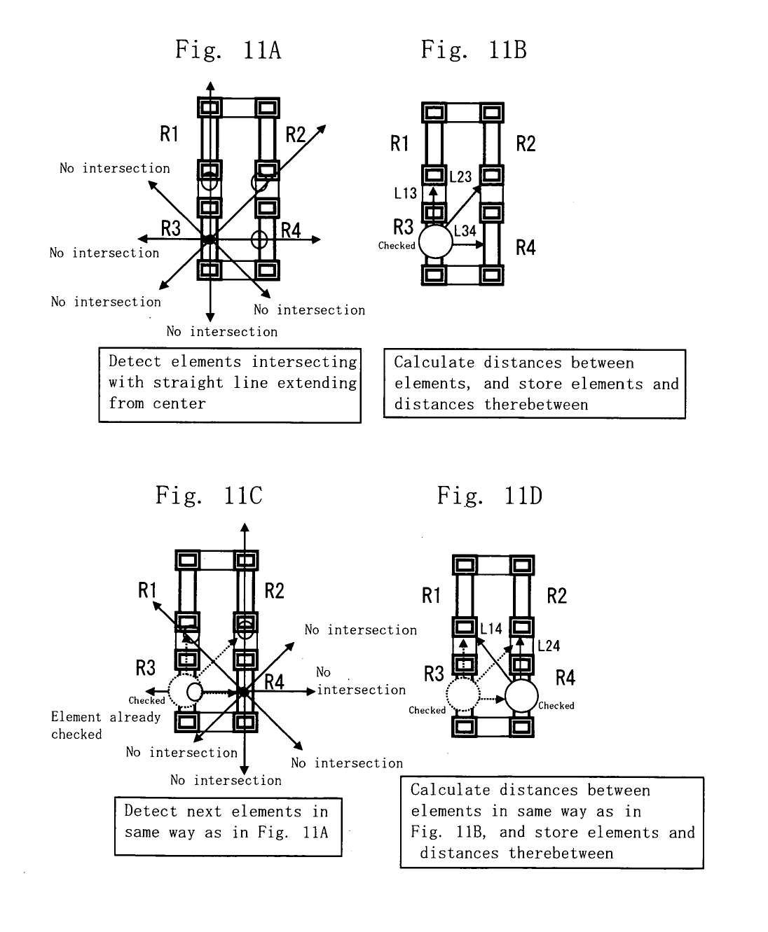

Furthermore, a concrete example of Step S12 shown in FIG. 8 will be described with reference to FIGS. 11A to 11D. In FIGS. 11A to 11D, the same circuit as that shown in FIGS. 4A to 4C will be described.

As shown in FIG. 1A, the resistive element, for instance, R3 is chosen from among all the elements, and then the elements R1, R2, and R4 which intersect with a probe line extending from the center of the resistive element R3 in eight directions are detected.

Next, as shown in FIG. 11B, distances L13, L23, and L34 from the resistive element R3 to the detected elements R1, R2, and R4 are calculated, the elements R1, R2, R4 are stored as adjacent elements of the resistive element R3 in conjunction with the distances.

Then, as shown in FIGS. 11C and 11D, the next element, for instance, the resistive element R4 is chosen, the resistive elements R1 and R2 which are adjacent to the resistive element R4 are detected in the same way as described above, and distances L14 and L24 from the resistive element R4 to the resistive elements R1 and R2 are calculated and stored. Here, since the adjacency relationship between the resistive elements R3 and R4 and the adjacency distance L34 have already been stored, they are not detected and stored.

Likewise, as to the remaining elements R1 and R2 as well, their adjacent elements are stored, and distances to the adjacent elements are calculated and stored. In this way, the adjacency relationships between all the elements are stored.

Here elements other than the resistive elements will be described. The electric characteristics of the elements other than the resistive elements depend upon their device model. As to their heat characteristics, their basic workings are the same as those of the resistors. That is, the flow of electricity through resistive components included in the elements generates heat, namely, produces heat quantity, and a part of the heat quantity is directly radiated from the elements to the substrate. And furthermore, as described above, the heat quantity is radiated to the adjacent elements via the thermally resistive component.

### INDUSTRIAL APPLICABILITY

As described above, the present invention is useful for circuit simulations which take account of temperature variations.

1. A circuit simulation method including steps of:
forming a simulation circuit wherein individual elements in the circuit to be simulated are represented as a device model having an electric model exhibiting electric characteristics of the element, in which the temperature variation of the element is taken into account, and having a thermal model exhibiting thermal characteristics of the element, and a thermal resistance between the two elements where heat exchange occurs is determined to be inserted between the thermal models of the device models corresponding to the two elements; and
determining dynamic variations in the electric and thermal characteristics of the individual elements in the circuit to be simulated through the analysis of the simulation circuit.

2. The circuit simulation method according to claim 1, wherein for the purpose of determining the thermal resistance between the two elements where the heat exchange occurs, the step of forming the simulation circuit includes steps of:
choosing any two of the elements placed so as to be adjacent to each other from a mask layout as the two elements where the heat exchange occurs; and
determining the thermal resistance between the elements based on a distance between the two elements placed so as to be adjacent to each other and a heat conductivity between the two elements.

3. A device model having an electric model and a thermal model for the purpose of representing each element in a circuit to be simulated, the electric model exhibiting electric characteristics of the element in which the temperature variation of the element is taken into account, the thermal model exhibiting thermal characteristics of the element.

4. A simulation circuit, wherein
individual elements in a circuit to be simulated are represented as a device model which has an electric model exhibiting electric characteristics of the element, in which the temperature variation of the element is taken into account, and which has a thermal model exhibiting thermal characteristics of the element, and
a thermal resistance between the two elements where heat exchange occurs is inserted between the thermal models of the device models corresponding to the two elements.
